(19) United States
(12) Patent Application Publication
(10) Pub. No.: US 2012/0133716 A1
(43) Pub. Date: May 31, 2012

(54) ULTRAVIOLET IRRADIATION DEVICE AND PRINTING DEVICE

(76) Inventors: Toshihiko Aizawa, Osaka (JP); Yoshiyuki Adachi, Wakayama (JP); Yasuhiro Tanaka, Wakayama (JP)

(21) Appl. No.: 13/322,958

(22) PCT Filed: Jun. 22, 2010
(86) PCT No.: PCT/JP10/60553

§ 371 Date: Feb. 7, 2012

(30) Foreign Application Priority Data
Jun. 26, 2009 (JP) 2009-152996

(51) Int. Cl. B41J 2/01

(52) U.S. Cl. 347/102

(57) ABSTRACT

An ultraviolet irradiation device 3 is comprised of an attachment 15 supported to a printing device and an LED unit 20 which is attachable/detachable to/from the attachment 15 by a sliding operation. The LED unit 20 includes an ultraviolet light emitting diode and is configured such that the unit 20 is attached to the attachment 15 by an inserting operation thereof into the attachment or detached therefrom by a drawing operation thereof from the attachment, the inserting and drawing operations both being possible by a single worker from a working area S.

### TECHNICAL FIELD

The present invention relates to an ultraviolet irradiation device for irradiating ultraviolet light on a printed face of a printed object which has undergone a printing operation at a printing section with using an ultraviolet-curable ink (“UV-curable ink” hereinafter). The invention relates also to a printing device having this ultraviolet irradiation device.

### BACKGROUND ART

As an example of the printing device configured as above, Patent Document 1 discloses a rotary letterpress printing machine including a plurality of printer units arranged along an outer circumferential face of an impression cylinder and ultraviolet irradiation devices disposed downstream of these printer units. With this rotary letterpress printing machine in operation, as a sheet of a soft vinyl chloride film or the like as a printed object (i.e. an object to be printed) is fed to the impression cylinder, this film is subjected to a transfer printing operation by the printer units with using the UV-curable ink; then, as the ultraviolet irradiation device irradiates ultraviolet light on the printed face, the UV-curable ink is cured.

Further, in Patent Document 1, a metal halide lamp is employed as the ultraviolet irradiation device. However, it is described in this same document that a chemical lamp or an ultrahigh pressure mercury lamp can be employed instead.

### PRIOR ART DOCUMENT

### Patent Document

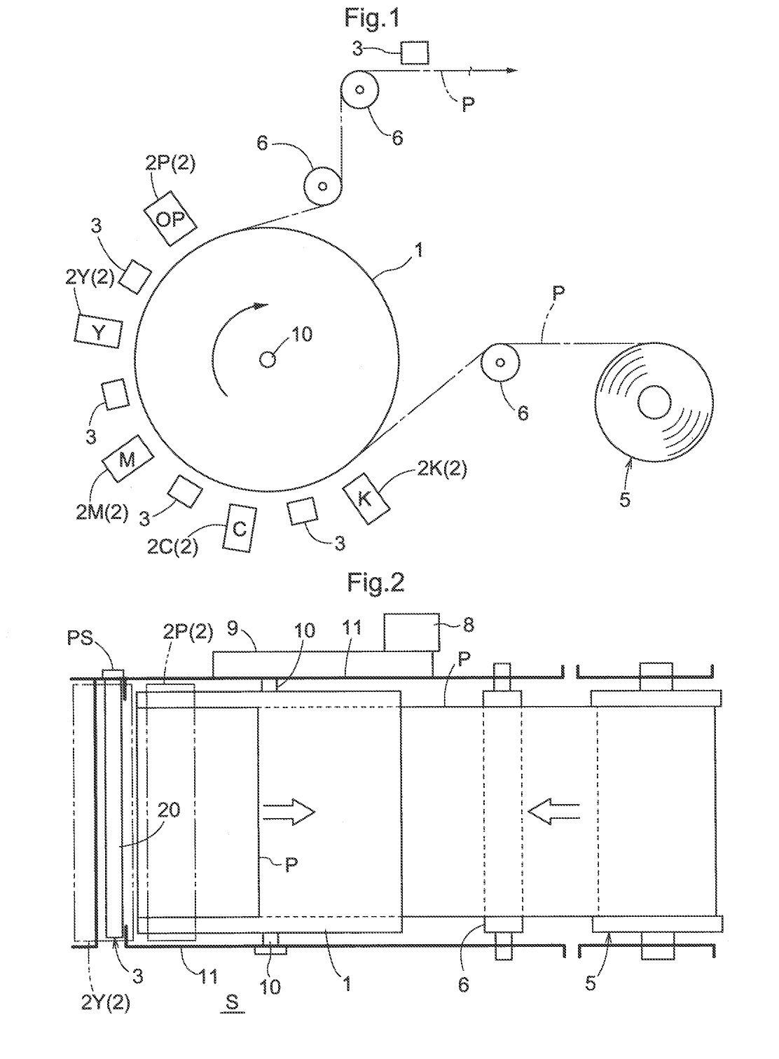

Patent Document 1: Japanese Unexamined Patent Application Publication No. 11-170683 (paragraphs [0010] through [0029], FIG. 1).

### SUMMARY OF THE INVENTION

### Object To Be Achieved by Invention

In the case of the arrangement such as the one employed in the printing device disclosed in Patent Document 1 wherein a printing operation is effected with an UV-curable ink and UV irradiation on the printed face is effected immediately after the printing operation, there is realized speedy curing of the UV-curable ink.

Further, as the UV source for curing the UV-curable ink, a high-pressure mercury lamp is commonly employed in view of obtaining sufficient light amount and the cost of the lamp.

With a high-pressure mercury lamp, a high output can be readily obtained, On the other hand, at present, one light source used in the printing device requires an electric power as much as 1 kilowatt or more; and due to the high source voltage, high insulating performance is required for the power system. Moreover, the high-pressure mercury lamp invites enlargement of the power unit including a ballast unit and requires its replacement when the use period thereof reaches 2000 hours approximately. In these respects, there remains room for improvement. In particular, for the replacement operation, this operation requires direct removal of the lamp, thus being often troublesome.

Recently, an LED unit having UV light emitting diodes has been proposed as an UV light source. This UV LED unit satisfies the need for power saving. Further, as its UV light emitting diode has much longer usable life than a lamp or the like, its use in the form of an LED unit as an UV irradiation unit is conceivable. Also, when the LED unit is employed in a printing device, the LED unit is to be detachably attached to the printing device for realizing easy maintenance such as replacement.

However, in attaching or detaching an LED unit having a significant length, this would often require two workers to stand on the opposed ends of the unit to effect bolt fastening/loosening operations, positioning operation of the unit, etc., respectively. With such mode of work, the work may require e.g. space sufficient for two workers to stand, and the two workers need to effect a same operation simultaneously. Hence, there was inconvenience of need to secure an adequate installment space for the printing device and two or more workers for the attaching/detaching operation.

The object of the present invention is to provide ingeniously an ultraviolet (UV) irradiation device that requires less trouble for its maintenance and to provide also a printing device including this UV irradiation device.

### Means for Accomplishing the Object

According to the characterizing feature of the present invention, there is provided an ultraviolet irradiation device for irradiating ultraviolet light on a printed face of a printed object which has undergone a printing operation at a printing section with using an ultraviolet-curable ink (“UV-curable ink” hereinafter), the device comprising:

an adaptor unit supported to the printing section; and an ultraviolet irradiation unit (“UV irradiation unit” hereinafter) detachably attached to the adaptor unit.

With the above arrangement, when the UV irradiation unit is attached to the adaptor unit supported to the printing section, it becomes possible for the device to effect UV irradiation on the printed face of the printed object which has undergone a printing operation at a printing section with using an UV-curable ink. When a replacement operation of the UV irradiation unit or a maintenance operation thereof is to be effected, the UV irradiation unit can be readily detached from the adaptor unit.

Consequently, there is provided ingeniously an ultraviolet (UV) irradiation device that requires less trouble for its maintenance.

In the present invention, preferably, the UV irradiation unit is attached to the adaptor unit by an inserting operation and is detached therefrom by a drawing operation; and the device further comprises a guide mechanism for displacing an UV irradiation face of the UV irradiation unit closer to the printed face of the printed object at the time of the inserting operation.

With the above arrangement, when an inserting operation is effected for inserting the UV irradiation unit to the adaptor unit, the guide mechanism displaces the UV irradiation face of the UV irradiation unit closer to the printed face of the printed object, so that the UV light can be irradiated form a position close to the printed face. Conversely, with a drawing operation for drawing the UV irradiation unit out of the adaptor unit, this UV irradiation unit can be detached from the adaptor unit.

Preferably, in the present invention, the UV irradiation unit includes a plurality of semiconductor light emitting elements for irradiating UV light, a contamination preventing plate formed of a transparent plate that covers the light emitting face of the light emitting element, a heat sink for discharging heat of the light emitting element, a cooling fan for feeding cooling air to the heat sink and a dustproof filter for removing dust from air be to bed to the cooling fan.

With the above arrangement, in the event of scattering of the UV curable ink from the printing section or the printed face toward the light emitting elements, this scattered ink will adhere to the contamination preventing plate, thus protecting the light emitting elements against contamination. Also, removal, of the ink adhered to the contamination preventing plate can be carried out easily. As cooling air is fed from the cooling fan to the heat sink, heat generated during light emission of the light emitting elements can be readily discharged by the heat sink. Moreover, any dust contained in the air to be fed to the cooling fan can be removed by the dust proof filter, so no dust will enter the inside of the UV irradiation unit.

According to the present invention, there is provided a printing device comprising a plurality of the UV irradiation devices having the above-described construction provided adjacent a plurality of printing sections that are arranged along an outer circumference of a center drum.

With this arrangement, there is provided a center drum type printing device having the UV irradiation devices that requires less trouble for its maintenance.

Alternatively in the present invention, the printing device comprises a plurality of the UV irradiation devices having the above arrangement provided adjacent a plurality of printing sections that are arranged along a conveying section for conveying the printed object horizontally.

With the above arrangement, there is provided a horizontal conveying type printing device having the UV irradiation devices that requires less trouble for its maintenance.

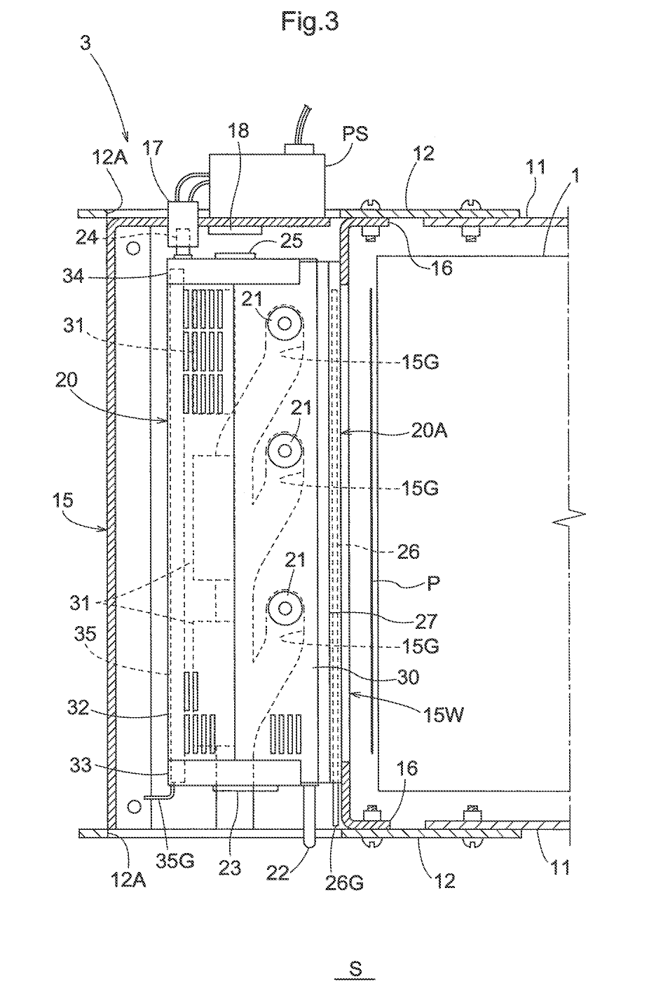

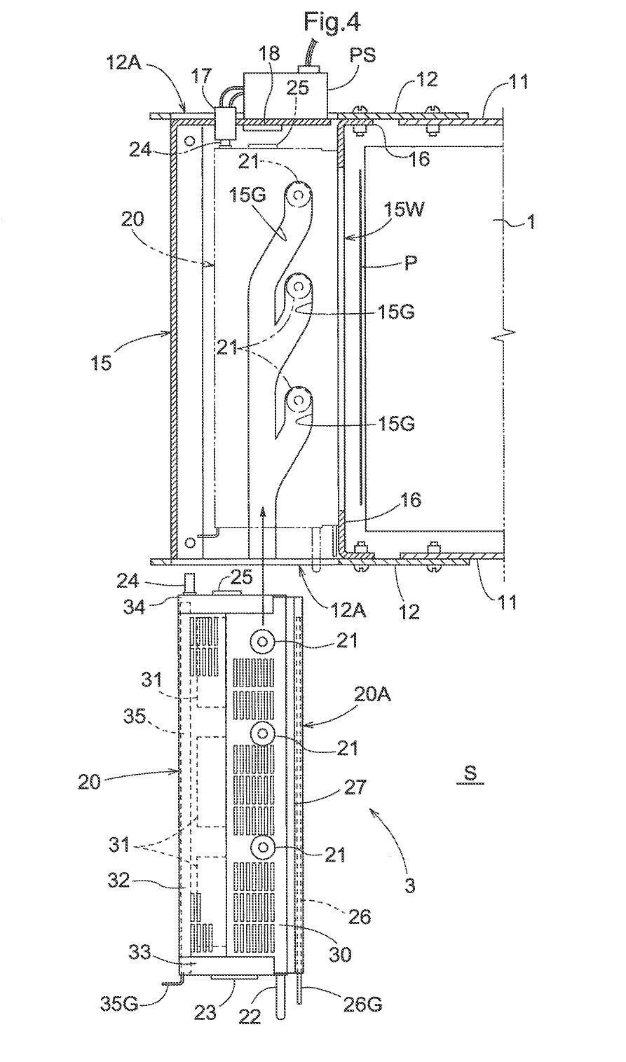

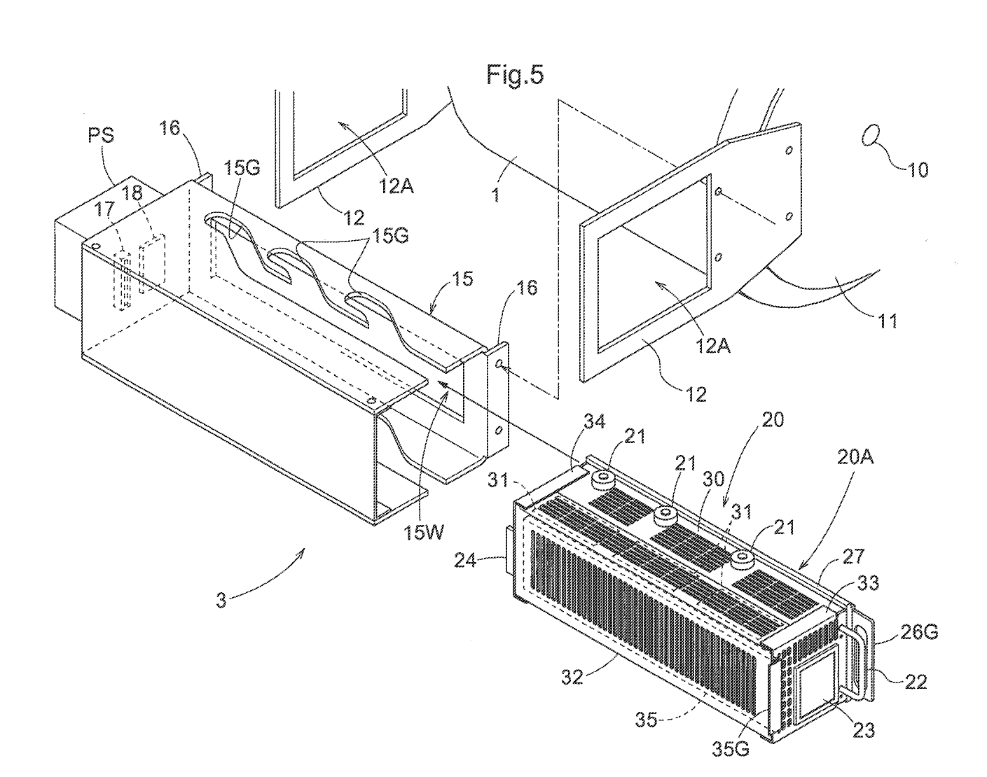

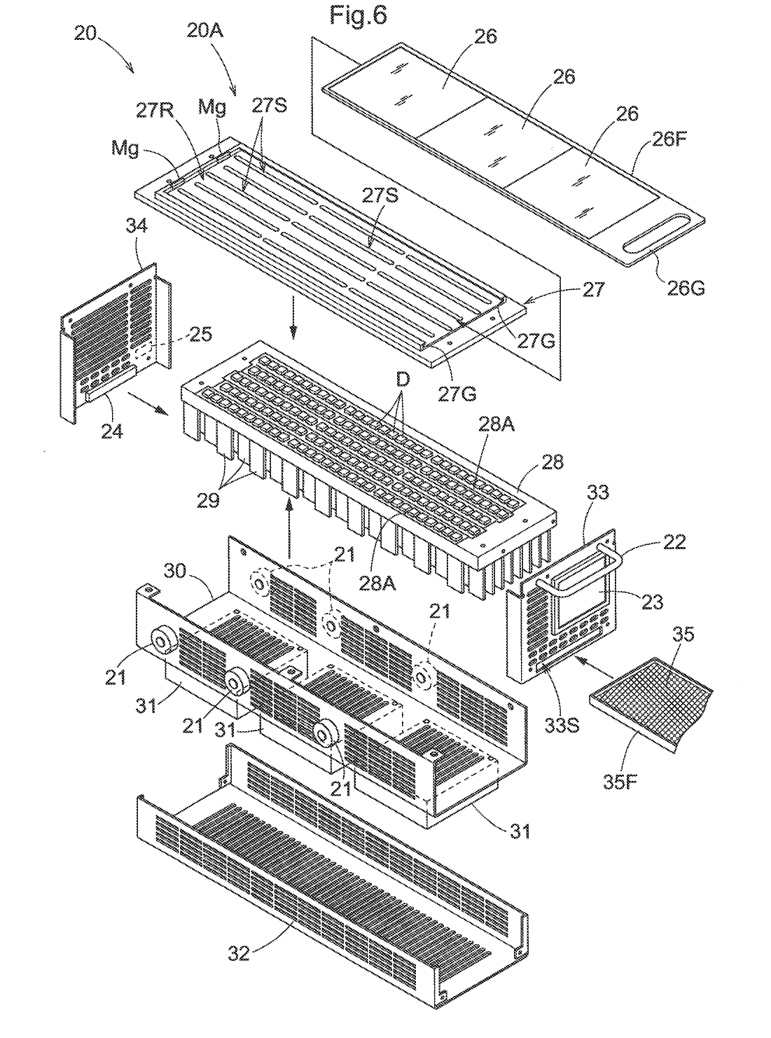

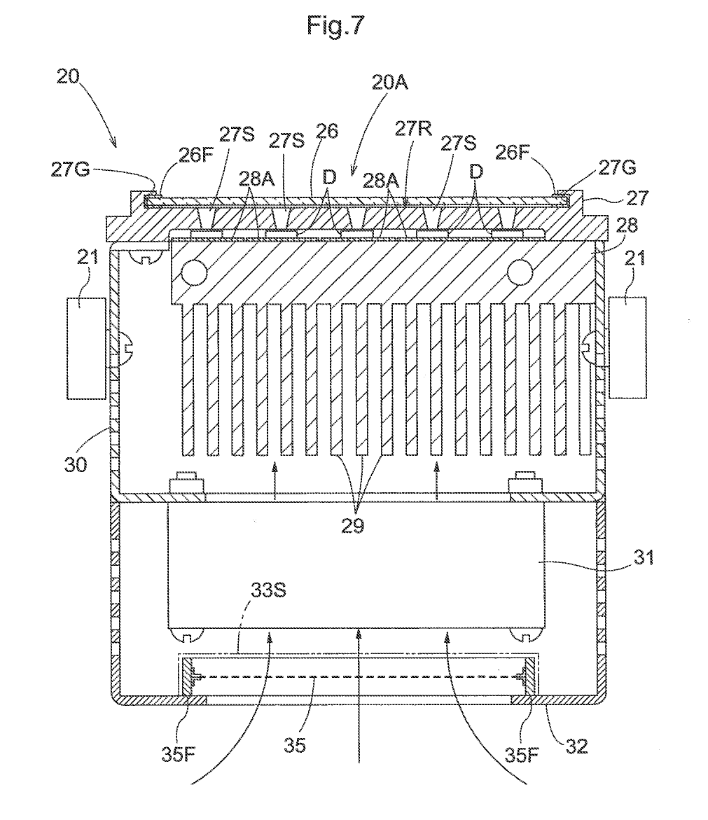

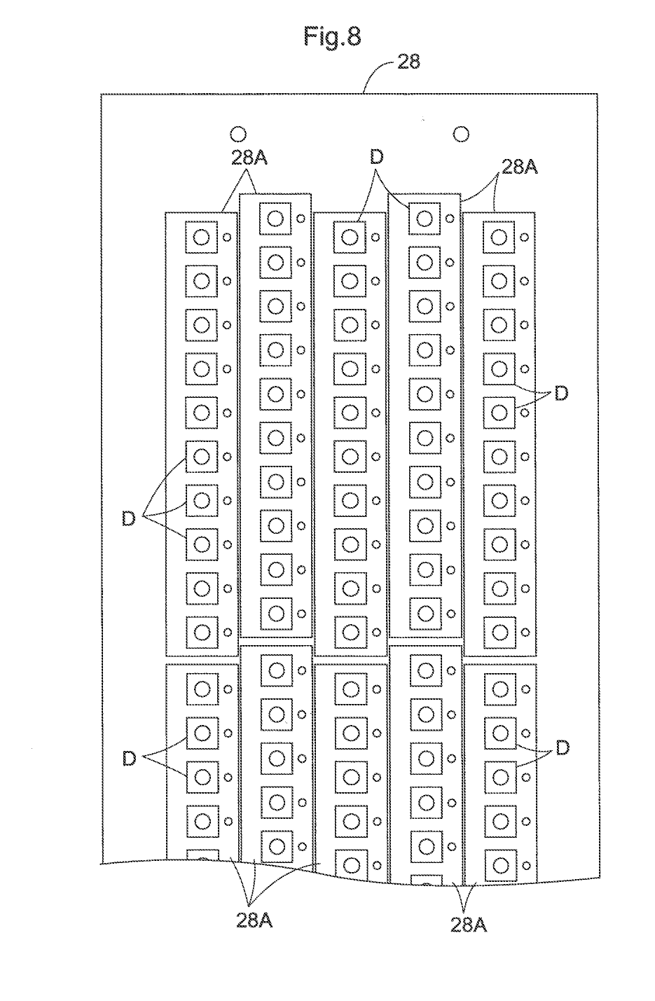

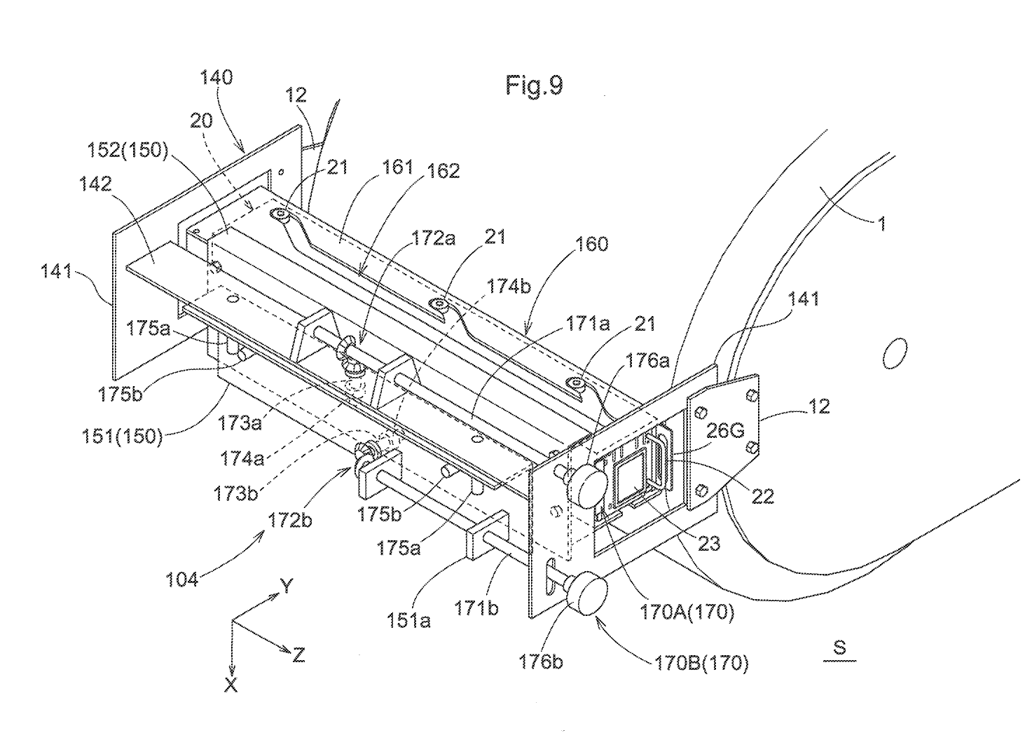

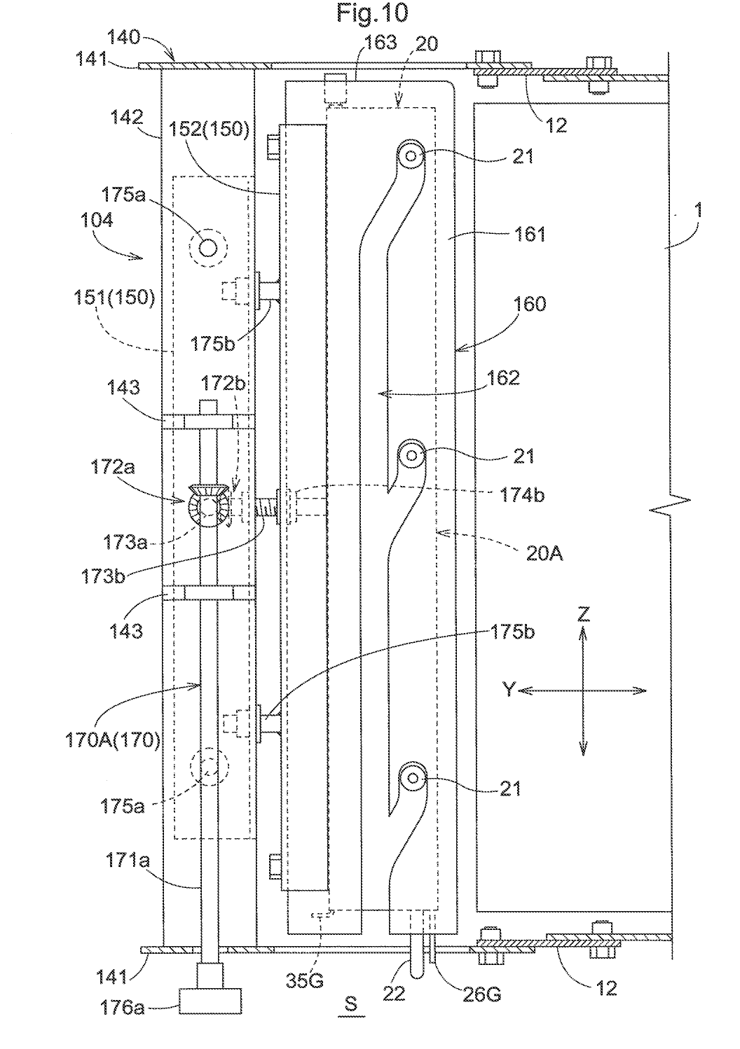

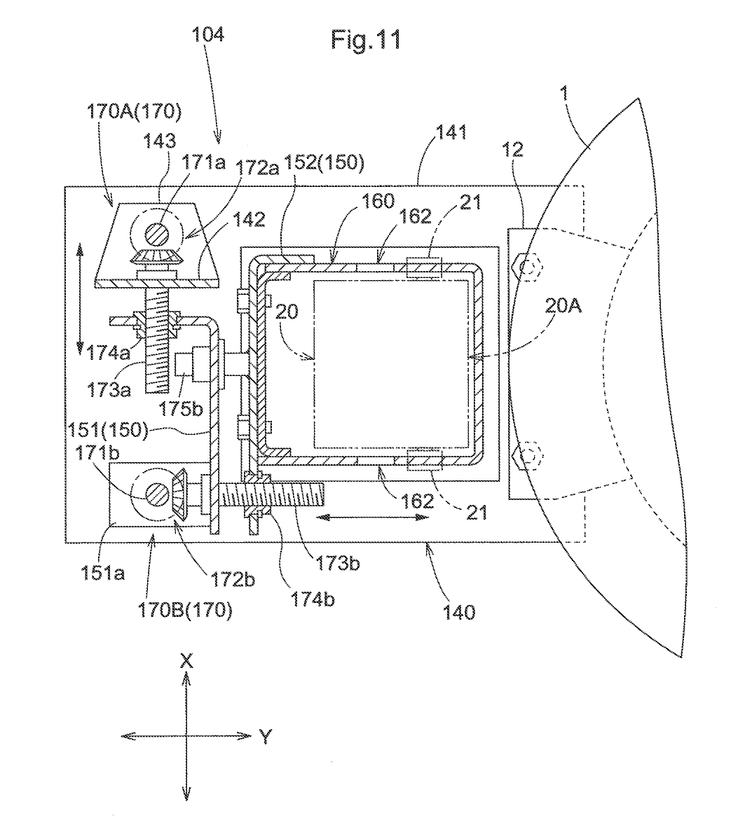

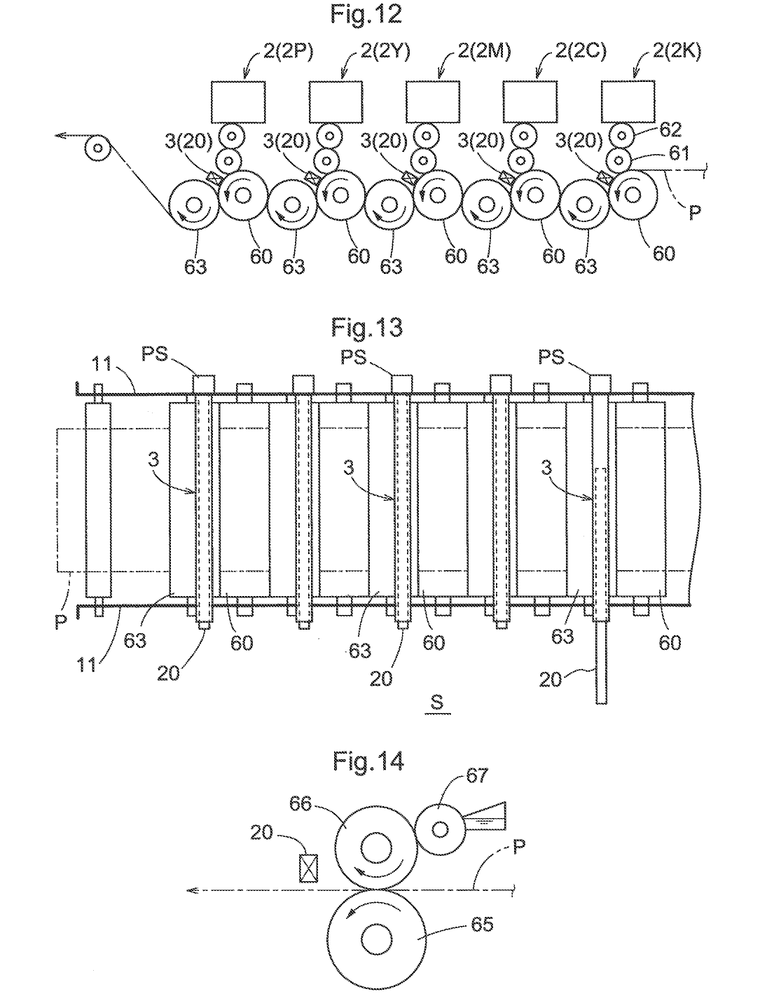

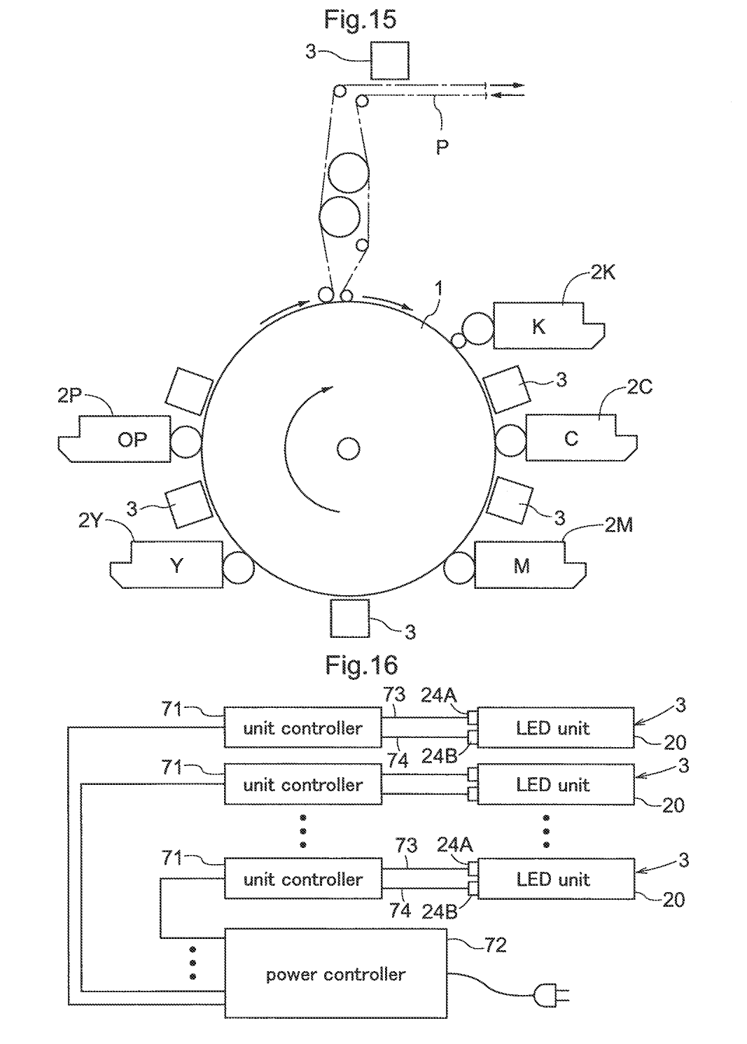

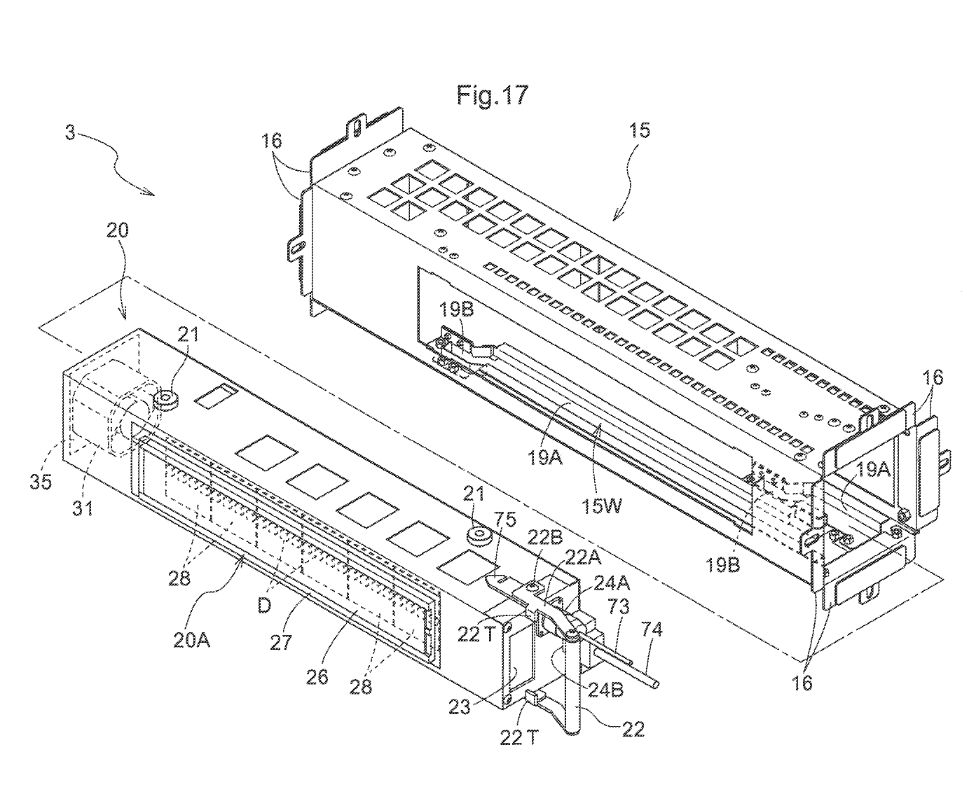

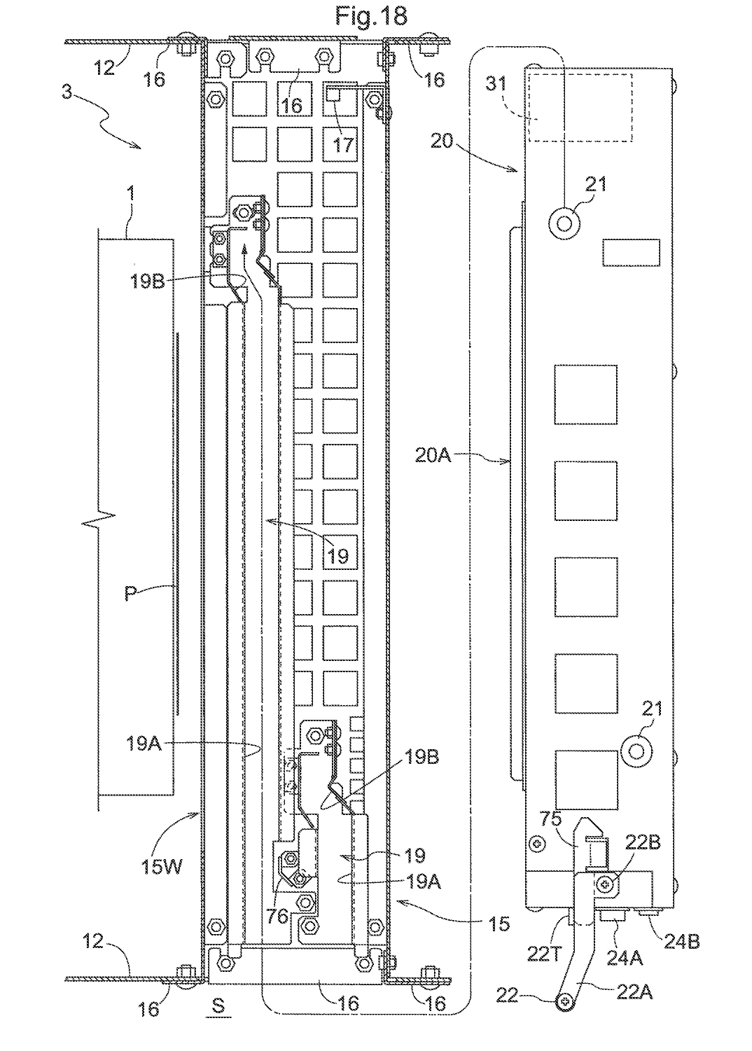

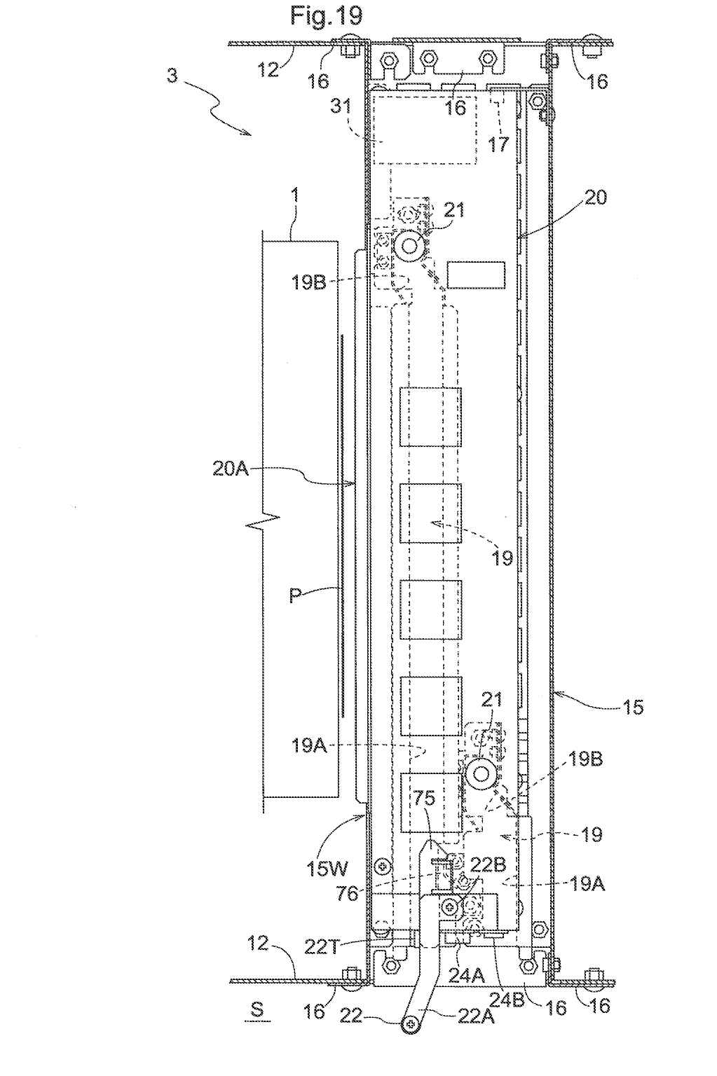

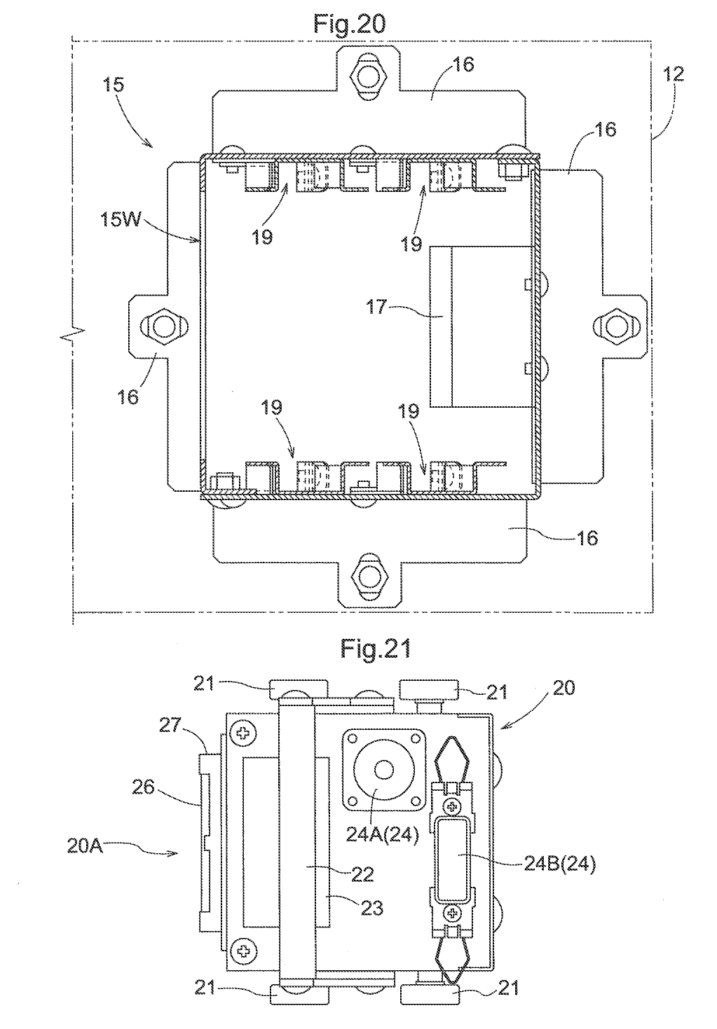

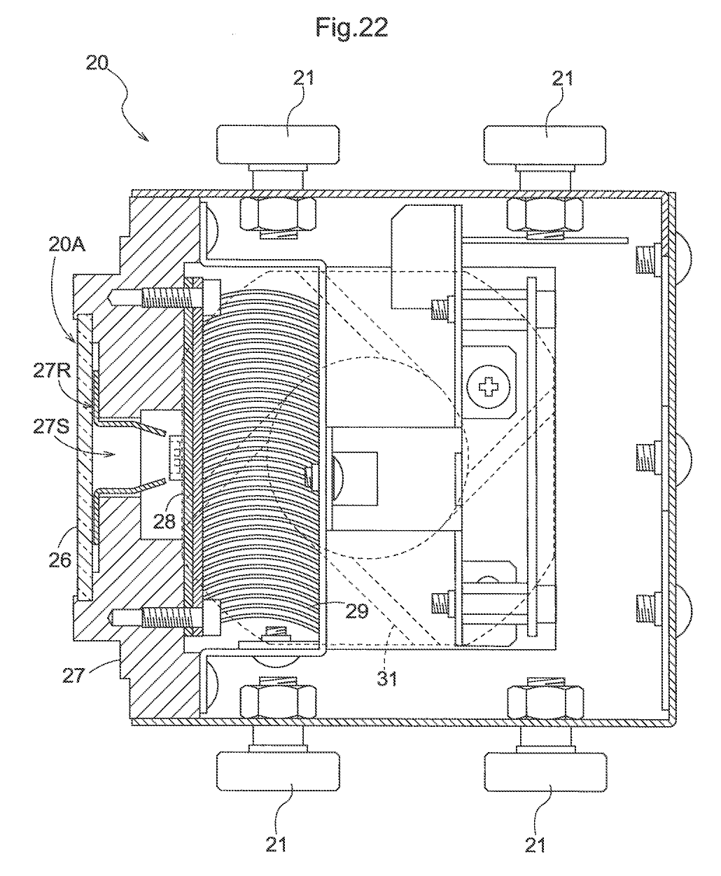

### BRIEF DESCRIPTION OF THE DRAWINGS

[FIG. 1] is a side view schematically showing an arrangement of a satellite type printing device according to a first embodiment,

[FIG. 2] is a plan view schematically showing the arrangement of the satellite type printing device according to the first embodiment,

[FIG. 3] is a plan view showing an LED unit, an attachment etc. under an attached state in the first embodiment,

[FIG. 4] is a plan view showing the LED unit, the attachment etc. under a detached state in the first embodiment,

[FIG. 5] a perspective view showing the LED unit, the attachment etc. in the first embodiment,

[FIG. 6] is an exploded perspective view of the LED unit in the first embodiment,

[FIG. 7] is a section view of the LED unit in the first embodiment,

[FIG. 8] is a plan view showing a support body and a substrate including UV LED in the first embodiment,

[FIG. 9] is a perspective view showing an adaptor unit with the LED unit attached thereto according to a further embodiment (a),

[FIG. 10] is a plan view showing an example of the adaptor unit according to the further embodiment (a),

[FIG. 11] is a front view showing an example of the adaptor unit according to the further embodiment (a),

[FIG. 12] is a side view schematically showing a printing device according to a further embodiment (b),

[FIG. 13] is a plan view schematically showing the printing device according to the further embodiment (b),

[FIG. 14] a side view showing the basic construction of a flexo type printing arrangement according to a further embodiment (c),

[FIG. 15] is a side view schematically showing an arrangement of a satellite type printing device according to a second embodiment,

[FIG. 16] is a circuit block diagram showing a control system relating to the second embodiment,

[FIG. 17] is a perspective view showing an attachment and an LED unit relating to the second embodiment,

[FIG. 18] is a plan view showing the attachment and the LED unit relating to the second embodiment,

[FIG. 19] is a section view showing an UV irradiation section relating to the second embodiment,

[FIG. 20] is a section view showing the attachment relating to the second embodiment,

[FIG. 21] is a side view showing a terminal end of the LED unit relating to the second embodiment, and

[FIG. 22] is a section view of the LED unit relating to the second embodiment.

### MODES OF EMBODYING THE INVENTION

Next, embodiments of the present invention will be described with reference to the accompanying drawings.

### Printing Device According to First Embodiment

As shown in FIG. 1 and FIG. 2, there is provided a satellite type printing device including a rotatably driven center drum 1, a plurality of printing units 2 (an example of “printing sections”) arranged along the outer circumference of this center drum 1, and a plurality of UV irradiation sections 3 as “UV irradiation devices” for irradiating UV light on a printed face of a printed object P which has undergone a printing operation.

With this printing device in operation, a sheet like printed object P set in a feeding section 5 in the form of a roll is fed continuously to the center drum 1 as being guided by guide rollers 6. In association with rotation of the center drum 1, each printing unit 2 effects a printing operation using a UV-curable ink by the letterpress printing technique on the printed face of the printed object P. The printed face immediately after this printing operation is then subjected to UV light (beam) irradiation by the UV irradiation unit 3 (an example of UV irradiation device) for curing the UV-curable ink.

The respective printing units 2 are provided in correspondence with at least four colors of black (K), cyan (C), magenta (M),and yellow (Y). As shown in the drawing, the plurality of printing units 2 are indicated by reference marks 2K, 2C, 2M, 2Y in correspondence with black (K), cyan (C), magenta (M),and yellow (Y), respectively. Another unit 2P shown in the drawing effects printing with transparent ink (OP) for the purpose of e.g. surface finish.

To the UV irradiation unit 3, there is detachably attached an LED unit 20 (an example of “UV irradiation unit”) having a large number of UV light emitting diodes D (an example of semiconductor light emitting elements. See FIG. 6 and FIG. 7). Each LED unit 20 has the function of irradiating ultraviolet light on the printed face which has undergone the printing operation with using the UV-curable ink by the printing unit 2 corresponding thereto so as to cure this ink. Alternatively, this UV irradiation unit 3 can employ UV laser diodes instead of the UV light emitting diodes D or a laser beam source for generating UV beam.

The plurality of LED units 20 all have a same shape and same dimensions, so that attachment and detachment thereof are possible by a worker (operator) from a work area S which is set on one side (one side of the printed object width P direction) relative to the direction perpendicular to a conveying passage of the printed object P in the printing device. That is, the LED unit 20 can be attached by an inserting operation of inserting an attachment 15 (an example of “adaptor unit”) to be described later, along the longitudinal direction thereof and can be detached by a drawing operation.

As shown in FIGS. 2-5, the printing device includes a pair of plate-like side frames 11 for rotatably supporting the opposed ends of drive shafts 10 of the center drum 1. And, a force transmission line 9 is provided for transmitting a drive force of an electric motor 8 to one drive shaft 10. Further, the pair of side frames 11 rotatably support the guide roller 6 and at one terminal end of the printing device, there is disposed a feeding section 5 for feeding the printed object in the form of a roll.

The attachment 15 as an adaptor unit is connected to brackets 12 mounted to the pair of side frames 11. And, to this attachment 15, the LED unit 20 as an UV irradiation unit, is supported to be attachable to and detachable therefrom by sliding operations. The bracket 12 has a construction having an aperture 12A which allows attachment of a mercury lamp type UV light source also if desired. And, at positions adjacent the apertures 12A of the pair of brackets 12, the attachment 15 is fixed by means of bolts.

The attachment 15 has a bottomed angular pipe-like shape and forms flange portions 16 at opposed ends along the longitudinal direction thereof. In one lateral side of the attachment, there is formed a slit-like guide groove 15G (a portion of a guide mechanism), and in the other lateral side thereof, an aperture 15W is formed. On the inner side of this attachment 15, there are provided a drawer connector receptacle portion 17 and an antenna unit 18 for effecting accessing of ID information in a non-contact manner with the LED unit 20. Further, on the outer face of the attachment 15 having the receptacle portion 17 (i.e. the opposite side to the work area 5), there is provided a power unit PS. The plurality of attachments 15 all have a same shape and dimensions to allow attachment of any LED unit 20 thereto.

[LED Unit]

The LED unit 20 is configured such that one face thereof forms an UV emitting section 20A. While the unit 20 can be used under any desired posture, in the following discussion, there will be explained a case wherein the unit assumes a posture with the UV emitting portion 20A faces upwards.

As shown in FIGS. 3 through 7, the LED unit 20 has a box-like configuration forming the UV emitting section 20A in its upper side and in the other sides excluding the UV emitting section 20A, the unit includes wall portions defining a great number of aeration grating portions. To the side face of this LED unit 20, there are rotatably supported a plurality of guide rollers 21 (another portion of the guide mechanism) engageable with the guide groove 15G (one portion of the guide mechanism) and at one terminal end, a handle 22 is provided. To this terminal face, there is mounted a liquid crystal display 23 forming a touch panel in its displaying face as a displaying means. Further, to the other terminal face of this LED unit 20, there are provided a drawer connector plug portion 24 and an ID information recording portion 25 comprised of RFID (Radio Frequency IDentification). The ID information recording portion 25 stores therein ID information unique to each LED unit 20.

The guide groove 15G mentioned above consists of a linear portion extending linearly along the printing width direction which is also the attaching direction of the LED unit 20 and three curved portions branched or curved from the linear portion to extend closer to the center drum 1. Further, each curved portion consists of an oblique groove part branched from the linear portion to extend obliquely closer to the center drum 1 and a further end groove part which is bent from the leading end of this oblique groove part to extend for a short distance in parallel with the linear portion. Further the distance between adjacent curved portions is set in agreement with the disposing pitch of the guide rollers 21 (another part of the guide mechanism). In operation, as the three guide rollers 21 are guided along the oblique groove parts of the respective curved portions, the guide rollers 21 displace the UV emitting section 20A of the LED unit 20 which has been inserted away from the printed face without interfering therewith, in the direction closer to the printed object. Subsequently, as the guide rollers 21 are guided along the end groove parts, the receptacle portion 17 and the plug portion 24 become connected to each other to reach an electrically connected state. Further, as the worker grips the handle 22 from work area S and then draws it out, the guide rollers 21 are guided in reverse in succession from the curved portions to the linear portions, whereby the LED unit 20 can be drawn out of and detached from the attachment 15.

In particular, the distance between the downstream side two branched or curved portions of the three such portions is made different from the distance between the subsequent branched portions (those on the work area S side) of the same and the three guide rollers 21 are disposed in correspondence with these distances. With this arrangement, in the course of insertion of the LED unit 20 into the attachment 15, even when the leading end guide roller 21 reaches the position for entering a branched portion other than the branched portion corresponding thereto, the next guide roller 21 does not reach the branched portion, so inconvenience of entrance to a non-corresponding branched portion is restricted by the above arrangement. That is, in the case of an arrangement wherein the distances between the three respective branched portions in the inserting direction of the LED unit 20 are set equal to the distances between the three respective guide rollers 21, this arrangement will invite the inconvenience of the leading end guide roller 21 inadvertently entering a non-corresponding branched portion. In this regard, with the above-described non-equal setting arrangement of the distances, the inconvenience of inadvertent entrance of a guide roller 21 entering a non-corresponding branched portion is prevented, so that the guide roller 21 will enter properly the guide roller 21 corresponding thereto.

In this first embodiment, the guide mechanism is comprised of the guide groove 150 formed in the attachment 15 and the plurality of guide rollers 21 provided in the LED unit 20. Instead, however, in the guide mechanism to be used in the present invention, the guide rollers 21 may be provided in the attachment 15 whereas the guide groove 150 may be formed in the LED unit 20. Further, the guide mechanism may employ a rail-like member rather than the guide groove. And, instead of the guide rollers, it is possible to employ a non-rotary type guide member which comes into contact with the rail-like member to be slidably guided thereon.

The UV emitting section 20A includes three contamination preventing plates 26 formed of e.g. quartz glass as a transparent material allowing UV transmission, and downwardly of this, there is provided a reflector member 27 having a reflecting face 27R and a slit-like aperture 278. And, further downwardly, there is provided a substrate 27 made of aluminum having a great number of UV light emitting diodes D. The lower face of this substrate 28 includes a plurality of heat sinks 29 in the form of projections therefrom. To an inner cover 30 covering the above components, there are mounted three cooling fans 31 and an outer cover 32 is provided for covering these. Further, at longitudinal end positions, there are provided a first end face cover 33 and a second end face cover 34.

As shown in FIG. 6, the three contamination preventing plates 26 are supported in a gapless manner within the inner circumference of a frame member 26F. And, at one longitudinal end of the frame member 26F, a grip 26G is formed integrally.

Incidentally, for enhancement of the sealing performance of the three contamination preventing plates 26, a sealing member can be provided along the outer circumference of the frame member 26F or the slide groove 27G. Further, in order to prevent intrusion of dust or the like into the space where the UV light emitting diodes D are disposed, a sealing member can be provided along the mutually contacting faces of the substrate 26 and the reflector member 27.

For forming the reflector member 27, a metal material such as aluminum, stainless steel or the like is employed. And, by polishing this material to give it a mirror-surface finish, the reflecting face 27R is formed in the upper side; and in the lower side, there is formed a recess for accommodating the plurality of UV light emitting diodes D. Further, in the front surface (upper side) of the reflector member 27, there are formed a pair of slide grooves 27G parallel with each other for slidably supporting the frame member 26F. These slide grooves 27G render the LED unit 20 open to or accessible from the work area S when the LED unit 20 is attached to the printing device. So, from this opened portion, the contamination preventing plates 26 can be inserted or withdrawn together with the frame member 26F relative to the slide grooves 27G.

Further, the frame member 26F is formed of a magnetic material such as an alloy containing iron or nickel. And, the reflector member 27 includes permanent magnets Mg for magnetically attracting the frame member 26F when the contamination preventing plates 26 are inserted to the proper attaching positions into the slide grooves 27G. Then, the frame member 26F made of magnetic material and the permanent magnets Mg together constitute a retaining mechanism. With this, as a worker present in the work area S grips the grip 26G, it is possible for this worker to effect attachment with insertion of the contamination preventing plates 26 and detachment with withdrawal of the same. And, when the plates have been inserted to the proper attaching positions, the terminal end of the frame member 26F is attracted and sucked to the permanent magnets Mg, whereby the attached condition is retained,

Incidentally, for constructing the retaining mechanism above, the permanent magnets Mg can be provided in the frame member 26F and a magnetic material or piece such as iron piece can be provided in the reflector member 27. As a further alternative construction of the retaining mechanism, the frame member 26F may include a recess, and a spring member or the like may be provided which comes into engagement with the recess when the frame member 26F is inserted to the proper position.

The contamination preventing plate 26, under its attached condition, assumes a posture parallel with the reflecting face 27R of the reflector 27 and the lower face of the frame member 26F is placed in gapless contact with the upper face of the reflector 27. With this, the contamination preventing plate 26 isolates the space where the UV light emitting diodes are provided from the outer space, whereby the space where the UV light emitting diodes are provided is maintained under the sealed state.

There has been observed a phenomenon that when UV light s irradiated on the UV-curable ink, a portion of the UV-curable ink will sublimate or evaporate, and then, this will adhere to any member present in the vicinity thereof and deposit. When this deposited substance adheres to the surface of the UV light emitting diode, there occurs reduction in the amount of UV light emitted therefrom. In this regard, as the space including the UV light emitting diodes is sealed by the contamination preventing plates 26, such undesirable adhesion of deposited substance to the surface of the UV light emitting diodes D or the reflector 27 can be effectively restricted. Further, although deposition substance will adhere to the contamination preventing plate 26, the worker can remove this contamination preventing plate 26 together with the frame 26F and wipe off the substance, so that removal of deposed substance can be readily carried out, and no reduction in the amount of UV emission will be invited.

As shown in FIG. 8, ten UV light emitting diodes D are grouped as one unit and this group of diodes D are linearly supported to one band-like supporting member 28A forming an insulating face. And, this supporting member 28A is detachably supported to the substrate 28. Though not shown, the ten UV light emitting diodes D supported to the supporting member 28A are connected in series, so that power is supplied from a constant current circuit to each supporting member 28A. Further, even when emitted light amount reduction occurs in one UV light emitting diode D included in one unit group, the supporting member 28A supporting the ten UV light emitting diodes D will be replaced entirely.

As shown in the same figure, the relative positional relationship among the supporting members 28A is set such that the UV light emitting diodes D are arranged in five columns, with adjacent UV emitting diodes D being arranged in zigzag pattern relative to each other. This zigzag layout of the adjacent ones of the columns of the UV light emitting diodes D overcomes the inconvenient phenomenon of light amount becoming non-uniform in the column direction. Incidentally, the number of the UV light emitting diodes D to be supported to the supporting member 28A is not limited to ten (10), but the number can be fewer or more than ten (10).

In particular, of the UV light emitting diodes D arranged in five columns, two columns of the UV light emitting diodes providing 385 nm wavelength performance are arranged upstream in the conveying direction of the printed object P and three columns of the UV light emitting diodes providing 365 nm wavelength performance are arranged downstream in this conveying direction.

With the above-described arrangement of disposing diodes having a longer wavelength upstream in the conveying direction of the printed object P and the diodes having a shorter wavelength downstream, curing of the ink is effected with the UV beam having the longer wavelength reaching the inner side of the ink and then the curing is effected for the surface of the ink with the UV beam having the shorter wavelength, whereby the curing of the ink can be effected in a reliable manner.

The positions of the slit-like apertures 27S of the reflector member 27 are set in such a manner as to allow these fives columns of UV light emitting diodes D to emit the beams linearly. Then, the UV beams emitted through the slit-like apertures 27S are irradiated onto the surface of the printed object P and the UV beams reflected from the printed face of the printed object P will reach the reflecting face 27R and reflected by this reflecting surface 27R and then transmitted to the printed face of the printed object P again

The inner cover 30 has the grating portion and is connected from the portion of the heat sinks 29 to the position for covering the substrate 28. In this inner cover 30 at the positions thereof immediately blow the heat sinks 29, there are provided three electrically driven cooling fans 31 for feeding cooling air to the heat sinks 29. The outer cover 32 has the grating portion and is disposed at a position for covering the cooling fans 31 and connected to the inner cover 30.

To the first end cover 33, there are attached the handle 22 and the liquid crystal display 23 and to the second end cover 34 opposite thereto, there are provided the plug portion 24 and the ID information storing portion 25 described hereinbefore.

The first end cover 33 defines a slit 33S which allows insertion and withdrawal of a dustproof filter 35 for removing dust contained if any in the air to be fed to the cooling fans 31. The dustproof filter 35 is supported to a rectangular frame 35F having a predetermined width along the thickness direction of the dustproof filter 35. And, at an end of this frame 35F, there is formed a grip portion 35G which can be gripped by a worker. And, the slit 33S formed in the first end cover 33 is formed with dimensions that allow insertion and withdrawal of the frame 35F. With the provision of this frame 35F, even when the dustproof filter 35 is withdrawn, it is possible to solve the inconvenience of the dust adhering to the surface of the dustproof filter 35 corning into contact with the opening edge of the slit 33S, thus being detached inadvertently.

With the provision of the cooling system described above, an ambient air suctioned through the grating portion in the bottom side of the outer cover 32 will be drawn to the cooling fans 31 with dust contained therein being removed by the dustproof filter 35 and fed to the heat sinks 29, and then the air will be discharged to the outside of the unit through the grating portion provided in the lateral side of the inner cover 30.

Though not shown, each power unit PS is connected via a communication network to a managing device, thereby to a realize a control system as follows. Namely, ON/OFF operations of power for the UV light emitting diodes are effected based on control signals transmitted from this managing device to the power unit PS. Further, the managing device is connected via the communication network to the antenna unit 18, so that ID information obtained from the ID information recording section 25 by the antenna unit 18 is transmitted to the managing device and information such as a message transmitted from the managing device is transmitted from the antenna unit 18 to be displayed on the liquid crystal display 23.

The liquid crystal display 23 displays e.g. a message indicating that the contamination preventing plate 26 or the dustproof filter 35 has reached a condition requiring its cleanup, a message indicating replacement timing of the LED unit 20, etc. Further, as the liquid crystal display 23 is disposed at a position facing the work area S, the worker when present in the work area S can visually confirm, based on the displayed contents of the LED unit 20, that timing has reached for replacement or needing maintenance. Hence, the worker can determined need or non-need for maintenance on the spot and can also effect cleaning of the dustproof filter 35 or the contamination preventing plate 26 and also replacement of the LED unit 20,

[Irradiation of Ultraviolet Beam]

In the LED unit 20 used in the present invention, the plurality of UV light emitting diodes D are arranged linearly along the direction normal to the conveying direction of the printed object P. Thus, the UV beams emitted form the plurality of columns of UV light emitting diodes D are sent out through the plurality of columns of slit like apertures 278 and are caused to reach the printed face of the printed object P through the contamination preventing plates 26.

In this way, when irradiation of UV beams is to be effected, as described hereinbefore, the curing of the ink portion (lower layer portion) which is in contact with the printed object P is allowed to proceed first with the UV having a longer wavelength, thus being more permeable to the ink and thereafter, the ink portion on the outer face side is effected with the UV having the shorter wavelength. With this arrangement, it is possible to avoid the inconvenience of the lower layer ink portion being left uncured.

In particular, a portion of the UV beam irradiated onto the printed face is reflected by the printed face toward the LED unit 20; yet, as this LTV beam reflected by the printed face is reflected by the reflecting face 27R of the reflector member 27 of the LED unit 20, the UV beam can be fed again to the printed face, so that no UV portion is wasted and the curing of the UV-curable ink can be promoted effectively.

In this way, according to the present invention, as the UV light emitting diodes of the LED unit 20 effect light emission even with a small voltage as small as a few bolts. Hence, even when ten UV light emitting diodes

D are used in series, the source voltage therefor can be as small as a few tens of volts, so that the LED unit 20 can be formed compact. Further, the power line can be formed simple, and moreover as the usable life of the unit is as long as seven times longer than that of a high pressure mercury lamp, the improvement of the useable life of the UV light source is made possible and frequency of replacement can be reduced as well.

In particular, attachment and detachment are possible from the work area S by a worker who grips the handle 22 of the LED unit 20 having the plurality of UV light emitting diodes D. Similarly, attachments and detachments of the dustproof filter 35 and of the contamination preventing plates 26 are possible from the work area S by the worker who grips the grip portion 35G of the filter 35 or the grip 26G of the contamination preventing plate 26. In this way, the maintenance operations from the work area S are facilitated. As a result, it becomes possible to install the printing device with such a positional relationship as having its face opposite away from the work area S being adjacent a wall surface. Consequently, there is achieved saving of installment space also.

### Modified Embodiments of First Embodiment

The present invention can be embodied differently from the foregoing embodiment.

[a] As shown in FIGS. 9 through 11, an arrangement is provided which allows positional adjustment of the LED unit 20 with use of a position adjusting means 170 in association with a rotational operation of an operational member 176a or an operational member 176b from the work area S.

More particularly, to a pair of side frames 11, respectively, a pair of brackets 12 are connected and for these brackets 12, there are provided adaptor units 104. The adaptor unit 104 is composed of a fixed adaptor portion 104 fixed to the side frame 11, a movable adaptor portion 150 displaceable along the X direction and Y direction extending perpendicularly to each other relative to the fixed adaptor portion 140, and an LED unit receiving portion 160 fixed (in this case, fixed by threading) to the movable adaptor portion 150. The LED unit receiving portion 160 has a tubular shape so that this portion 160 is capable of receiving and accommodating the LED unit 20 as being nested therein.

The LED unit receiving portion 160 has a bottomed angular pipe-like shape and in its opposed two side walls 161, slit-like guide grooves 162 are formed.

The movable adaptor portion 150 comprises a divided structure consisting of a first movable deck 151 and a. second movable deck 152. The first movable deck 151 is connected and supported by a print conveying direction displacing mechanism 170A for displacing the deck along the X direction relative to a cross plate 142 of the fixed adaptor portion 140. Further, the second movable deck 152 is connected and supported by a vertical approaching/receding displacement mechanism 170B for displacing the deck along the Y direction relative to the first movable deck 151.

The print conveying direction displacing mechanism 170A includes an operational shaft 171a extending along the Z direction (direction perpendicular to the X direction and the Y direction), a lead screw shaft 173a extending along the X direction, a bevel gear unit 172a as a direction changing power transmitting means for transmitting a rotational force of the operational shaft 171a to the lead screw shaft 173a, a ball member 174a threaded on the lead screw shaft 173a, and a pair of guide rods 175a extending along the X direction in parallel with the lead screw shaft 173a at the opposed ends of the lead screw shaft 173a. The operational shaft 171a is rotatably supported by a bearing bracket 143 provided to a cross plate 142. Further, on an extension shaft portion of the operational shaft 171a extending through the bracket plate 141 and projecting to the outside, there is attached an operational member 176a for rotationally operating this operational shaft 171a. The bevel gear unit 172a as a direction changing power transmitting means can be replaced by any other direction changing power transmitting means such as a pair of worm gears, etc. Though not shown, the screw shaft 173a is supported to the cross plate 142 with a bush or the like to be rotatable, but not axially movable. The ball member 174a, as being well-known as a thread feeding mechanism, is a movable member which cooperates with the lead screw shaft 173a. In this case, the ball member 174a is fixed to the first movable deck 151. Therefore, the ball member 174a, consequently the first movable deck 151, is displaced along the X direction in response to rotation of the lead screw shaft 173a. The guide rod 175a guides the displacement along the X direction of the first movable deck 151.

The vertical approaching/receding displacement mechanism 170B has an essentially similar construction as the print conveying displacement mechanism 170A, that is, the mechanism 170B includes an operational shaft 171b extending along the Z direction, a lead screw shaft 173b extending along the Y direction, a bevel gear unit 172b as a direction changing power transmitting means for transmitting a rotational force of the operational shaft 171b to the lead screw shaft 173b, a ball member 174b threaded on the lead screw shaft 173b, and a pair of guide rods 175b extending along the Y direction in parallel with the lead screw shaft 173b at the opposed ends of the lead screw shaft 173b. The operational shaft 171b is rotatably supported by a bearing bracket 151 a provided to the first movable deck 151. Further, on an extension shaft portion of the operational shaft 176b extending through the bracket plate 141 and projecting to the outside, there is attached an operational member 176b for rotationally operating this operational shaft 171b. Incidentally, since this operational shaft 171b is displaced along the X direction relative to the fixed adaptor portion 140, that is, relative to the bracket plate 141, a through hole provided in the bracket plate 141 for allowing passage of the operational shaft 171b therethrough is formed as an elongate hole or cutout which extends long the X direction. In this case too, the bevel gear unit 172a as a direction changing power transmitting means can be replaced by any other direction changing power transmitting means such as a pair of worm gears, etc. Though not shown, the screw shaft 173b is supported to the first movable deck 151 with a bush or the like to be rotatable, but not axially movable. The ball member 174b is a movable member which cooperates with the lead screw shaft 173b. In this case, the ball member 174b is fixed to the second movable deck 152. Therefore, the ball member 174b, consequently the second movable deck 152 is displaced along the Y direction in response to rotation of the lead screw shaft 173b. The guide rod 175b guides the displacement along the Y direction of the second movable deck 152.

With the above-described arrangement in operation, as a worker rotatably operates the operational member 176a from the work area S, the LED unit 20 is displaced along the X direction, that is, substantially along the conveying direction of the printed object. Similarly, when the worker operates the operational member 176b from the work area S, approaching/receding displacement of the LED unit 20 occurs along the Y direction, that is, along the direction perpendicular to the printed face of the printed object. With this, after the LED unit 20 is inserted into the LED unit receiving portion 160 of this adaptor unit 104, the position of the LED unit 20 as specified can be carried out easily, thus optimum UV irradiation to the printed object being made possible.

(b) Instead of the satellite type printing device, the invention can be applied also to a sheet-fed offset printing device as shown in FIGS. 12 and 13. As shown, the sheet-fed offset printing device includes a plurality of impression cylinders 60 and a plurality of printing units 2 disposed at positions opposed thereto linearly along the conveying direction of the printed object P (horizontal direction), each printing unit be composed of a rubber cylinder 61 for contacting the impression cylinder, a plate cylinder 62 for transferring an amount of UV-curable ink onto the rubber cylinder 61 and a transfer cylinder 63 for feeding the printed object P. In the figures, the same components as those in the above construction are indicated by same reference numerals or marks. Incidentally, the present invention can be applied also to an intermittent operation type printing device.

In this printing device, the LED unit 20 as an UV irradiation section 3 is disposed in the vicinity of the printed object P fed by the impression cylinder 60. And, this LED unit 20 is configured to allow its attachment and detachment to be effected from the work area S. Therefore, in this modified embodiment too, from the work areas S provided on one side of the width direction of the printed object P, an operator (worker) can carry out attachment and detachment of the LED unit 20.

(c) As shown in FIG. 14, the present invention can be applied also to a flexo printing type printing device including an impression cylinder 65, a plate cylinder 66 disposed at a position opposed thereto, and an anilox roller 67 as a printing unit 2 for transferring an amount of UV-curable ink onto the plate cylinder 66. With this printing device, the printed face of the printed object P fed from the impression cylinder 65 is subjected to UV irradiation from the LED unit 20 as the UV irradiation section 3. In the figure, the same components as those in the above construction are indicated by same reference numerals or marks,

In this printing device, the LED unit 20 as an UV irradiation section 3 is disposed in the vicinity of the printed object P fed by the impression cylinder 65. In this flexo printing arrangement, the conveying mode of the printed object P can be made different such as the center drum type or the inline type. However, in whichever mode of conveyance, the LED unit 20 can be attached or detached from the work area S. Therefore, in this further embodiment too, from the work area S provided on one side of the width direction of the printed object P, an operator (worker) can carry out attachment and detachment of the LED unit 20.

(d) An arrangement is provided for selectively providing a state wherein the frame member 26F or the like for the contamination preventing plate 26 connected with a screw or the like to the UV emitting section 20A of the LED unit 20 or a state where the connection using a screw of the like can be released for allowing detachment.

With the above-described arrangement, when the LED unit 20 is detached from the attachment 15 for the purpose of maintenance, any substance adhering to the surface of the contamination preventing plate 26 can be manually wiped off. Moreover, even without the arrangement of slidably supporting the contamination preventing plate 26 to the LED unit 20, it is still possible to detach the contamination preventing plate 26 from the LED unit 20 for removal of adhering substance.

### Printing Device According to Second Embodiment

In this second embodiment, those components having the same functions as in the foregoing first embodiment are indicated by the same reference numerals or marks as the first embodiment.

As shown in FIG. 15, in this second embodiment, like the first embodiment, there is provided a satellite type printing device comprising a rotatably driven center drum 1, a plurality of printing units (an example of printing sections) disposed along the outer circumference of the center drum 1, and a plurality of UV irradiation sections 3 as UV irradiation devices for irradiating UV beam onto a printed face of a printed object P which has undergone a printing operation. As shown in FIGS. 17-22, each UV irradiation section 3 (an example of UV irradiation device) includes an attachment 15 (an example of “adopter unit”) as an adaptor unit and an LED unit 20 as a UV irradiation unit detachably attached to the attachment 15. However, the constructions of the attachment 15 and the LED unit 20 (an example of “UV irradiation unit”) are different from the first embodiment.

Further, in this second embodiment, as shown in FIG. 16, for the plurality of LED units 20, a plurality of unit controllers 71 are provided in the number corresponding to the number of the LED units 20. And, there is provided a single power controller 72 for supplying electric power to these unit controllers 71.

More particularly, the attachment 15 is formed like an angular pipe as shown in FIG. 17 and FIG. 20 and includes flange portions 16 at the longitudinal opposed end portions thereof. A plurality of brackets 12 are provided to a pair of side frames (not shown) of the printing device. And, to these brackets 12, the flange portions 16 provided at the end portions of the attachment 15 are connected. Incidentally, the attachments 15 of the plurality of UV irradiation sections 3 all have a same shape and dimensions and the plurality of LED units 20 too all have a same shape and dimensions. And, any desired one of the LED units 20 can be attached and detached by a worker (operator) from the work area S, so that any one of the LED units 20 can be attached to any one of the attachments 15.

Referring more particularly to this attachment 15, an aperture 15W is formed in this face opposed to the center drum 1 and of the inner faces of this attachment 15, the upper inner face and the lower inner face include two sets of guide rails 19 (a part of “guide mechanism”). Further, the LED unit 20 is configured such that its attachment is effected by its insertion operation to the attachment 15 along the longitudinal direction and its detachment is effected by its drawing operation therefrom. On the outer face, there are mounted guide rollers 21 (another part of the “guide mechanism”) corresponding to the guide rails 19.

The guide rails 19 are provided in a pair, as one set, that clamp one guide roller 21 therebetween. And, as shown in FIG. 18 and FIG. 19, one set of guide rails 19 include a linear portion 19A for linearly guiding the guide roller 21 of the LED unit 20 inserted from a terminal end of the attachment 15 and an inclined portion 19B for displacing the guide roller 21 toward the aperture 15W.

In one side of this LED unit 20, a UV emission section 20A is formed and at one longitudinal end thereof, a handle 22 is provided. At this end portion, as shown in FIG. 17 and FIG. 21, there are provided a power plug 24A and a control plug 24B. To the power plug 24A, a power cable 73 is connected; and to the control plug 24B, a control cable 74 is connected. Then, as shown in FIG. 16, the power cable 73 and the control cable 74 are connected to a unit controller 71, so that this unit controller 71 supplies electric power to the light emitting diodes and the cooling fan 31 of the LED unit 20 and also controls these components. Incidentally, the power controller 72 manages the plurality of unit controllers 71, like setting the LED units 20 to be supplied with power in correspondence with the number of printing colors in the printing device.

The handle 22 is supported to outer end portions of a pair of arm portions 22A and base end portions of these paired arm portions 22A are pivotally supported about a support shaft 22B. As shown in FIGS. 17 through 19, there are provided a pair of lock arms 75 pivotable about the support shaft 22B. Each lock arm 75 is urged by a spring (not shown) so as to maintain its state engaged with a lock piece 76 and in the arm portion 22A, there is formed a contact piece 22T for pivoting the lock arm 75 in the direction to be separated from the lock piece 76. And, on the inner face of the attachment 15, there are provided a pair of lock pieces 75 for coming into engagement with the pair of lock arms 75 when the LED unit 20 has been inserted to a proper position.

With the above-described arrangement in operation, when the LED unit 20 is inserted to the attachment 15, the guide rollers 21 are guided along the guide rails 19 and immediately before arrival at the proper position, the inclined portion 19B of the guide rail 19 displaces the guide roller 21 toward the aperture 15W. With this, through this aperture 15W, the LED unit 20 as a whole is displaced in the direction for bringing the UV emission section 20a closer to the printed face.

And, upon realization of arrival of the LED unit 20 at the proper position, as shown in FIG. 19, the UV emission section 20A will project through the aperture 15W and the lock arms 75 come into engagement with the lock pieces 76, thus realizing a locked state. Under this locked state, withdrawal of the LED unit 20 from the attachment 15 is prevented. Further, under this locked state, if the handle 22 is operated in the lock releasing direction, the contact piece 22T, as pivoting about the support shaft 22B of the arm portion 22A, will come into contact with the lock arm 75, so that the lock piece 76 is separated from the lock arm 75, thus releasing the locked state, whereby withdrawal of the LED unit 20 is realized.

In this second embodiment, the guide rails 19 provided on the inner face of the attachment 15 and the plurality of guide rollers 21 provided in the LED unit 20 together constitute the guide mechanism. However, in the guide mechanism used in the present invention, the guide rollers 21 can be provided in the attachment 15 and the guide rails 19 may be formed in the LED unit 20. Further, instead of the guide rollers 21, it is also possible to employ a non-rotary type guide member which comes into contact with the rail-like member to be slidably guided thereon.

The UV emitting section 20A of the LED unit 20, as shown in FIG. 17 and FIG. 22, includes a contamination preventing plate 26 formed of quartz glass. Arid, relative to this contamination preventing plate 26 as a reference, inside the LED unit 20, there are provided a reflector member 27 defining slit-like aperture and a plurality of substrates 28, with the respective substrates 28 being positioned adjacent each other. Further, there are provided a column of UV light emitting diodes as semiconductor light emitting elements provided on each substrate 28. At the other end of the LED unit 20, there is provided a cooling fan 31 for introducing ambient air through a dustproof filter 35 (see FIG. 17). And, a cooling air supplying passage for supplying the cooling air from the cooling fan 31 to a heat sink 29 provided inside the substrate 28 is formed inside the LED unit 20. This UV irradiation unit 3 can employ UV laser diodes instead of the UV light emitting diodes.

The plurality of UV light emitting diodes D are to be disposed within an opening formed in the reflector member 27, and in this opening, a reflecting face 27R is attached. One substrate 28 includes a set number (e.g. four) of UV light emitting diodes D. And, there is provided a power controlling system for supplying power to the set number of UV light emitting diodes D provided on one substrate 28.

With the above-described construction in operation, when the LED unit 20 is to be attached to the attachment 15, the unit can be attached and locked appropriately at a proper position simply by a worker (operator)'s operation from the work area. S of operating the handle 22 for inserting the LED unit 20. Further, when the LED unit 20 is to be detached, the worker can simply operate the handle 22 to pull out the unit, such that the locked state can be released to allow the detachment.

And, at the time of printing operation, the UV beams from the UV light emitting diodes D are irradiated onto the printed face of the printed object F, and the UV beams reflected from the printed face are reflected by the reflecting face 27R of the reflector member 27 to be sent back to the printed face, whereby curing of the ink is made possible without any waste of the emitted UV beams. Moreover, as the contamination preventing plate 26 is provided, even if ink or the like adheres to this contamination preventing plate 26, this can be easily wiped off. Also, the cooling of the UV light emitting diodes D too is made possible by the cooling air from the cooling fan 31.

As power is supplied for the set number of UV light emitting diodes as a set number, brightness of the set number of UV light emitting diodes can be readily adjusted.

In this second embodiment also, like the first embodiment described above, instead of the satellite type printing device, the invention can be applied also to a horizontal conveying type printing device such as a sheet-fed offset printing device or a sheet-fed offset printing device configured to effect printing while conveying the printed object horizontally.

### INDUSTRIAL APPLICABILITY

The present invention can be used in printing devices in general configured to effect printing with using UV-curable ink and can be used also in a printing device configured to effect printing on both front and back faces of the printed object.

### DESCRIPTION OF REFERENCE NUMERALS AND MARKS

1 center drum
2 printing section (printing unit)
3 UV irradiation device (UV irradiation section)
15 adaptor unit (attachment)
20 UV irradiation unit (LED unit)
26 contamination preventing plate
29 heat sink
31 cooling fan
35 dustproof filter
D semiconductor light emitting element (ultraviolet light emitting diode)
P printed object (object to be printed)

What is claimed is:

1. An ultraviolet irradiation device for irradiating ultraviolet light on a printed face of a printed object which has undergone a printing operation at a printing section with using an ultraviolet-curable ink, the device comprising:
an adaptor unit supported to the printing section; and
an ultraviolet irradiation unit detachably attached to the adaptor unit.

2. The UV irradiation device according to claim 1, wherein the UV irradiation unit is attached to the adaptor unit by an inserting operation and is detached therefrom by a drawing operation; and the device further comprises a guide mechanism for displacing an UV irradiation face of the LI irradiation unit closer to the printed face of the printed object at the time of the inserting operation.

3. The UV irradiation device according to claim 1, wherein the UV irradiation unit includes a plurality of semiconductor light emitting elements for irradiating UV light, a contamination preventing plate formed of a transparent plate that covers the light emitting face of the light emitting element, a heat sink for discharging heat of the light emitting element, a cooling fan for feeding cooling air to the heat sink and a dust proof filter for removing dust from air be to bed to the cooling fan.

4. A printing device comprising a plurality of the UV irradiation devices according to claim 1, provided adjacent a plurality of printing sections that are arranged along an outer circumference of a center drum.

5. A printing device comprising a plurality of the UV irradiation devices according to claim 1 provided adjacent a plurality of printing sections that are arranged along a conveying section for conveying the printed object horizontally.
